(19) United States
(12) Patent Application Publication
(10) Pub. No.: US 2024/0177878 A1
(43) Pub. Date: May 30, 2024

(54) METHOD OF EVALUATING THERMAL-HYDRAULIC ANALYSIS OF CONTAINMENT FACILITY AND COMPUTER PROGRAM FOR EXECUTING THE METHOD

(71) Applicant: KEPCO ENGINEERING & CONSTRUCTION COMPANY, INC., Gyeongsangbuk-do (KR)

(72) Inventors: Sun Hong YOON, Suwon-si (KR); Sun Chang MOON, Gimcheon-si (KR); Jae Seung MOON, Yuseong-gu (KR); Yong Ju CHO, Gimcheon-si (KR); Seok Jeong PARK, Seo-gu (KR); Seong Ho JEE, Seo-gu (KR)

(21) Appl. No.: 18/383,789

(22) Filed: Oct. 25, 2023

(30) Foreign Application Priority Data
Nov. 29, 2022 (KR) 10-2022-0162344
Feb. 14, 2023 (KR) 10-2023-0019540

(51) Int. Cl. G21D 3/04; G21D 3/00

(52) U.S. Cl. CPC G21D 3/04; G21D 3/005

(57) ABSTRACT

According to embodiments, modeling through evaluation of thermal-hydraulic analysis of a unique containment facility may be provided. Also, orders for nuclear power plants in other countries may be obtained, and a relative technological advantage may be achieved among nuclear power plant developing countries. In addition, a power plant may be designed through conservative and realistic modeling, and costs required for power plant design may be reduced by optimizing a design margin of a containment facility.

### CROSS-REFERENCE TO RELATED APPLICATION

This application is based on and claims priority under 35 U.S.C. § 119 to Korean Patent Application Nos. 10-2022-0162344, filed on Nov. 29, 2022, and 10-2023-0019540, filed on Feb. 14, 2023, in the Korean Intellectual Property Office, the disclosures of which are incorporated by reference herein in their entirety.

### BACKGROUND

### 1. Field

The disclosure relates to a method of evaluating thermal-hydraulic analysis of a containment facility and a computer program for executing the method, and more particularly, to a method, in which values for analyzing the pressure and temperature of a containment facility are calculated by using mass and energy (M/E) emitted to the containment facility during a design standard accident as an input and using a containment analysis package (CAP).

### 2. Description of the Related Art

Regarding a prior art, heavy water reactor safety analysis methodology does not consider uncertainty in the analyzed results. Other methods used also do not verify uncertainty.

Recently, licensing agencies are requesting uncertainty about values calculated in the process of licensing thermal hydraulic codes, fuel codes, and moderator 3 dimensional evaluation codes.

Reflecting this reality, verification of the uncertainty of safety analysis codes is being delayed. This delay in verification also delays the licensing process. Delays in these licensing procedures cause enormous economic losses.

Prior document Ser. No. 14/089,529 discloses that the total kinetic energy of each part is calculated using numerically simulated structural response along with element masses and added mass contributions, and the kinetic energy results for each part are reported to the user. Prior document Ser. No. 14/089,529 discloses that the added mass contribution to each finite element can be realistically assigned and the kinetic energy KE for a specific part can be summed by a predetermined formula.

Prior document Ser. No. 15/300,599 discloses a method for measuring the flow rate of a thermal mass flow meter. Prior document Ser. No. 15/300,599 discloses calculating the mass flow rate of the fluid flowing through the passage based on the mass flow rate of the fluid.

### SUMMARY

An objective of the disclosure is to provide modeling through evaluation of thermal-hydraulic analysis of a unique containment facility.

Provided is a device and method capable of obtaining orders for nuclear power plants of other countries and preoccupying a relative technological advantage among nuclear power plant developing countries.

Provided is a device and method capable of designing a power plant through conservative and realistic modeling and reducing cost required for designing a power plant by optimizing a design margin of a containment facility.

Additional aspects will be set forth in part in the description which follows and, in part, will be apparent from the description, or may be learned by practice of the presented embodiments of the disclosure.

According to an aspect of the disclosure, a method of evaluating a thermal-hydraulic analysis of a containment facility includes inputting, by a device for thermal-hydraulic analysis of a containment facility, data about a technical standard necessary for analyzing emission of mass and energy (M/E), analyzing, by the device for the thermal-hydraulic analysis of a containment facility, short-term M/E data, by using at least one of containment facility geometric modeling, initial condition modeling, and containment facility active/passive heat sink modeling, analyzing, by the device for the thermal-hydraulic analysis of a containment facility, long-term M/E data by reflecting linkages of back pressure conditions of the containment facility, calculating, by the device for the thermal-hydraulic analysis of a containment facility, an expected pressure and temperature (P/T) value by applying the short-term M/E data and the long-term M/E data to at least one of a flash model, an interface evaporation/condensation model, a condensation heat transfer model of a heat sink, and containment facility geometric modeling, and evaluating, by the device for the thermal-hydraulic analysis of a containment facility, that the containment facility is safe when the expected P/T value is less than a preset target value, and evaluating that the containment facility is not safe when the expected P/T value exceeds the preset target value.

The data about the technical standard may include data reflecting at least one of a general design criteria (GDC), a standard review plan (SRP), and American National Standards Institute (ANSI).

In the containment facility geometric modeling, the containment facility may be simulated with a cylindrical drywell, the containment facility may be simulated by reflecting an incontainment refueling water storage tank (IRWST) and a heat sink phenomenon of a new reactor type, and modeling may be performed with respect to heat transfer through a containment facility heat sink by using a condensation heat transfer film model in which non-condensable gas exists is used.

In the initial condition modeling, the containment facility may be simulated with multi-drywells, and modeling may be performed with respect to condensation heat transfer by using a diffusion layer model (DLM), Uchida and Tagami model.

In the initial condition modeling, when a containment facility coolant flows into a containment facility drywell, modeling may be performed by assuming that the coolant is immediately mixed with steam to reach thermal equilibrium.

In the initial condition modeling, modeling may be performed by using a water tank surface model in which a condensation mass transfer multiplication constant is set to a number of 1.0 or less.

In the initial condition modeling, modeling may be performed by using a Linehan model and a Lloyd-Moran model.

In the containment facility active/passive heat sink modeling, modeling may be performed by using a linearly interpolated condensation heat transfer model.

In the containment facility active/passive heat sink modeling, modeling may be performed by using a linearly interpolated Uchida model.

In the containment facility active/passive heat sink modeling, modeling may be performed by using a water tank surface heat transfer model to which a Mechanistic method and a Phasic Bulk transfer method are applied.

The calculating of the expected P/T value may be performed by using modeling implemented by using containment analysis package (CAP) code.

According to another aspect of the disclosure, a computer-readable storage medium includes a computer program stored thereon to execute any one of the methods according to embodiments by using a computer.

In addition, a computer-readable storage medium includes computer programs executing other methods for implementing the disclosure, other systems, and the above method recorded thereon.

Other aspects, features and advantages other than those described above will become apparent from the following drawings, claims and detailed description of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a schematic flowchart of a method of evaluating thermal-hydraulic analysis of a containment facility, according to embodiments;

FIG. 2 is a detailed flowchart of a method of evaluating thermal-hydraulic analysis of a containment facility, according to embodiments;

FIG. 3 is a block diagram of a device for the thermal-hydraulic analysis of a containment facility, according to embodiments;

FIG. 4 is a diagram showing an example of a heat transfer model used for short-term analysis modeling or long-term analysis modeling;

FIG. 5 is a diagram showing an example of modeling expected P/T calculations, according to embodiments;

FIG. 6 is a diagram showing four types of modeling used in an operation of performing short-term analysis modeling;

FIG. 7 is a diagram showing an example of short-term M/E data generated according to a first technical condition;

FIG. 8 is a diagram showing an example of short-term M/E data generated according to a second technical condition; and

FIG. 9 is a diagram shown an example of an expected P/T value calculated according to embodiments.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description. As used herein, the term “and/or” includes any and all combinations of one or more of the associated listed items. Expressions such as “at least one of,” when preceding a list of elements, modify the entire list of elements and do not modify the individual elements of the list.

Hereinafter, the configuration and application of the disclosure will be described more fully with reference to the accompanying drawings, in which embodiments of the disclosure are shown.

The disclosure may, however, be embodied in many different forms, and particular embodiments are illustrated in the drawings and described in detail in the detailed description. Effects and features of the disclosure, and method of achieving the same will become clear with reference to the embodiments to be described below together with the drawings. However, the disclosure should not be construed as being limited to the embodiments disclosed below and is embodied in many different forms.

Hereinafter, the embodiments are described in detail with reference to the accompanying drawings. In the descriptions with reference to the drawings, like reference numerals denote like components or corresponding components, and thus their redundant descriptions will be omitted.

In this disclosure, the terms such as “training” or “learning” are not intended to refer to mental activities such as human educational activities but are interpreted as terms indicating that they are performed through computation according to procedures.

In the following embodiments, while such terms as “first,” “second,” etc., may be used to described various components, such components must not be limited to the above terms.

In the following embodiments, an expression used in the singular encompasses the expression of the plural, unless it has a clearly different meaning in the context.

In the following embodiments, it is to be understood that the terms such as “including,” “having,” and “comprising” are intended to indicate the existence of the features or components disclosed in the specification, and are not intended the possibility that one or more other features or components may be added.

Sizes of components in the drawings may be exaggerated for convenience of explanation. In other words, since sizes and thicknesses of components in the drawings are arbitrarily illustrated for convenience of explanation, the following embodiments are not limited thereto.

When a certain embodiment may be implemented differently, a specific process order may be performed differently from the described order. For example, two consecutively described processes may be performed substantially at the same time or performed in an order opposite to the described order.

A containment facility is the last barrier of the defense-in-depth concept, which prevents radioactive materials from being leaked from a reactor coolant system (RCS) to the outside. The containment facility should be designed to maintain its integrity from dynamic loads imposed during design standard accidents including a loss of coolant accident (LOCA). Also, during an accident, environmental limitation conditions of the containment facility and safety-related systems, devices, and structures must not be exceeded. The performance of the safety-related equipment and devices having a safety class of Class 1E should be ensured such that a power plant may safely stop.

A thermal-hydraulic analysis of such a containment facility largely consists of a method of calculating the mass and energy (M/E) of the containment facility and a method of calculating the pressure and temperature (P/T) of the containment facility. An evaluation is made as realistically and conservatively as possible according to the requirements of Code of Federal Regulations (CFR), General Design Criteria (GDC), Standard Review Plan (SRP), and American National Standards Institute (ANSI), which are established by the U.S. Nuclear Regulatory Commission (NRC).

In the disclosure, M/E data is data generated through a code for a thermal-hydraulic phenomenon and a thermal transient analysis code, which refers to data necessary to simulate a change in mass and energy of a coolant released from a pressure boundary of the RCS when a large break loss of coolant accident (LBOCA) or the like among containment facility design standard accidents occurs.—To simulate a coolant, M/E data, i.e., mass and energy data, is required.

In the disclosure, short-term M/E data and long-term M/E data have a difference in that short-term M/E data is used for analyzing the maximum P/T of a containment facility, and long-term M/E data is preferably used for observing whether handling facilities or the like may alleviate the P/T of a containment facility. The difference between short-term M/E data and long-term M/E data may be differently set for each design standard accident. In a small-break loss-of-coolant accident (SBLOCA), the break area ranges from 0.05 ft² to 0.5 ft², while in a large-break loss-of-coolant accident (LBLOCA), it occurs during a guillotine break. In such cases, reactor coolant is released from the reactor building due to the difference in break areas. The mass and energy of the released reactor coolant constitute the short-term M/E data and/or long-term M/E data, which can be determined at the end of post-reflood (EOPR) time.

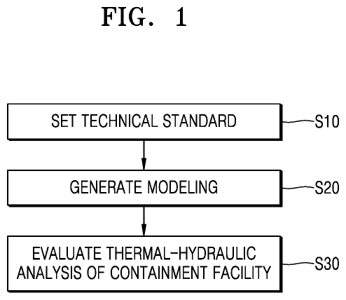

FIG. 1 is a flowchart of a method of evaluating thermal-hydraulic analysis of a containment facility, according to embodiments.

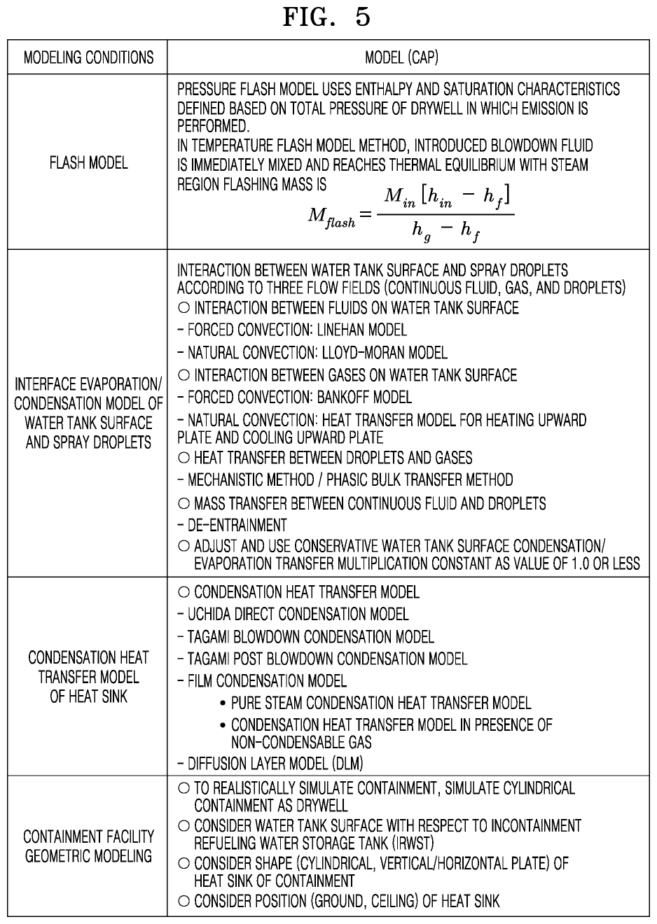

The method of evaluating the thermal-hydraulic analysis of the containment facility may include operation S10 of setting a technical standard, operation S20 of generating modeling for the thermal-hydraulic analysis for the containment facility, and operation S30 of evaluating the thermal-hydraulic analysis of the containment facility. Each of the operations may be performed by a device 100 (refer to FIG. 5) for the thermal-hydraulic analysis of the containment facility.

According to embodiments, in operation S10 of setting the technical standard, a standard necessary for analyzing the emission of mass and energy of the containment facility may be set. Such a standard may be obtained as input data. The standard input through operation S10 of setting the technical standard may include assuming the stork quantity at primary and secondary sides as a maximum value by assuming a coolant inventory on the primary and secondary sides is a maximum value within a settable range using thermal expansion and manufacturing tolerance, assuming the pressure and temperature of a primary system as maximum values within settable ranges, assuming a water level of a pressurizer as a maximum value within a settable range and a flow rate of an RCS as a minimum value within a settable range, assuming a plugging rate of a steam generator as a minimum value within a settable range, applying a conservative M/E emission model, and applying a conservative decay heat model considering uncertainty. In the above, the settable range may be changed by an administrator.

Herein, the conservative M/E emission model may refer to setting the mass and energy analysis value to the maximum value within a range of the mass and energy analysis values calculated through the model. The conservative decay heat model may refer to setting the decay heat value to the maximum value within a range of the decay heat values calculated through the model. By setting the mass and energy analysis value and decay heat value to the maximum values, the impact or damage of an accident can be set to the maximum. The meaning of conservative is not limited to the above and may be interpreted as a value with the highest accuracy or a value having the highest probability of occurrence.

In operation S10 of setting the technical standard, the device 100 for the thermal-hydraulic analysis of the containment facility sets a standard necessary for analyzing the P/T of the containment. The device 100 for the thermal-hydraulic analysis of the containment facility may receive, input, and obtain data about the necessary standard. Such a standard may be obtained as input data. The standard input through operation S10 of setting the technical standard may include setting a volume value of the containment facility as a minimum value, assuming the P/E of the containment facility as a maximum value, setting the relative humidity in the containment facility to 5%, reducing the surface area of a heat sink and applying a Tagami/Uchida condensation model and a natural convection model, ignoring radiant heat, eliminating heat transfer between steam and a water tank from heat transfer at a water tank interface, using a Droplet model during blowdown from a fracture flow model, assuming spray according to ANSI requirements, and considering the conservativeness of a heat removal system, or the like. The standard input may be changed.

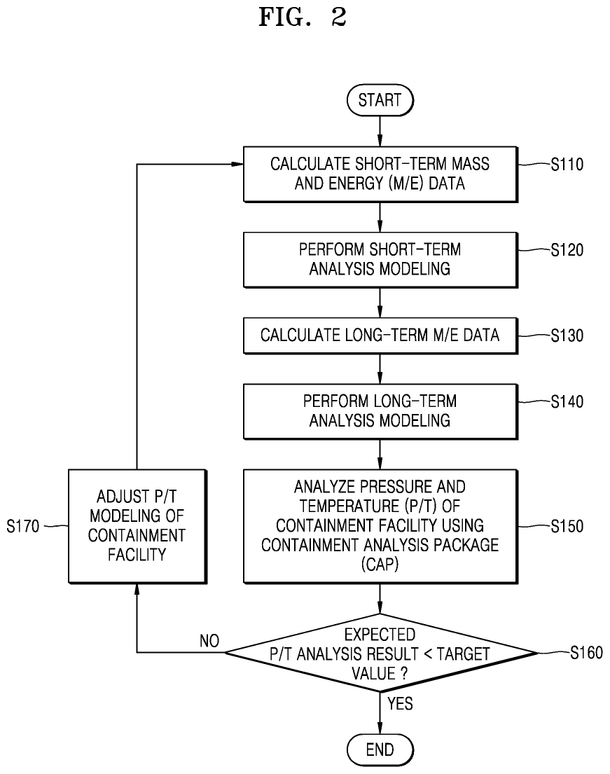

Operation S20 of generating modeling is an operation of generating modeling for the thermal-hydraulic analysis of a containment facility. In FIG. 2, operation S20 of generating the modeling may include operation S110 of calculating short-term M/E data, operation S120 of performing short-term analysis modeling, operation S130 of calculating long-term M/E data, operation S140 of performing long-term analysis modeling, and operation S150 of analyzing the P/T of a containment facility using a CAP.

To perform M/E modeling, short-term M/E data may be calculated, and short-term analysis modeling may be performed based on the short-term M/E data. In addition, long-term M/E data may be calculated, and long-term analysis modeling may be performed based on the long-term M/E data.

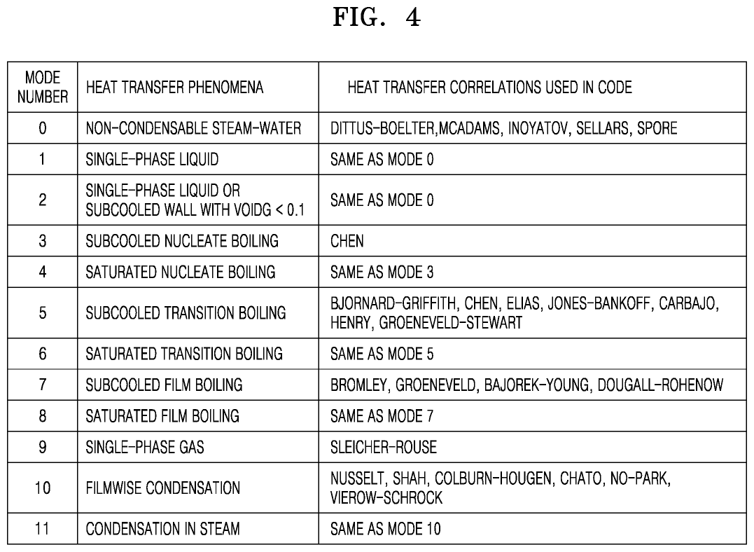

The M/E short-term analysis modeling and/or long-term analysis modeling may perform short-term analysis or long-term analysis by using the methodology shown in FIG. 4 as a heat transfer model. As shown in FIG. 4, for non-condensable steam water, at least one of coefficients of Dittus-Boelter, McAdams, Inoyatov, Sellars, and Spore may be used. For single-phase liquid, at least one of the coefficients of Dittus-Boelter, McAdams, Inoyatov, Sellars, and Spore may be used. For single-phase liquid or subcooled wall with void fraction<0.1, at least one of the coefficients of Dittus-Boelter, McAdams, Inoyatov, Sellars, and Spore may be used. For subcooled nucleate boiling, a coefficient of Chen may be used. For saturated nucleate boiling, the coefficient of Chen may be used. For subcooled transition boiling, at least one of coefficients of Bjornard-Griffith, Chen, Elias, Jones-Bankoff, Carbajo, Henry, and Groeneveld-Stewart may be used. For saturated transition boiling, at least one of the coefficients of Bjornard-Griffith, Chen, Elias, Jones-Bankoff, Carbajo, Henry, and Groeneveld-Stewart may be used. For subcooled film boiling, at least one of coefficients of Bromley, Groeneveld, Bajorek-Young, and Dougall-Rohenow may be used. For saturated film boiling, at least one of the coefficients of Bromley, Groeneveld, Bajorek-Young, and Dougall-Rohenow may be used. For single-phase gas, a coefficient of Sleicher-Rouse may be used. For filmwise condensation, at least one of coefficients of Nusselt, Shah, Colburn-Hougen, Chato, No-Park, and Vierow-Schrock may be used. For condensation in steam, at least one of the coefficients of Nusselt, Shah, Colburn-Hougen, Chato, No-Park, and Vierow-Schrock may be used. As described above, with respect to eleven heat transfer phenomena, result values may be calculated by using respective methodologies.

In operation S110 of calculating short-term M/E data, short-term M/E data may be calculated by applying a conservative thermal-hydraulic option model or an emission option for long-term cooling analysis.

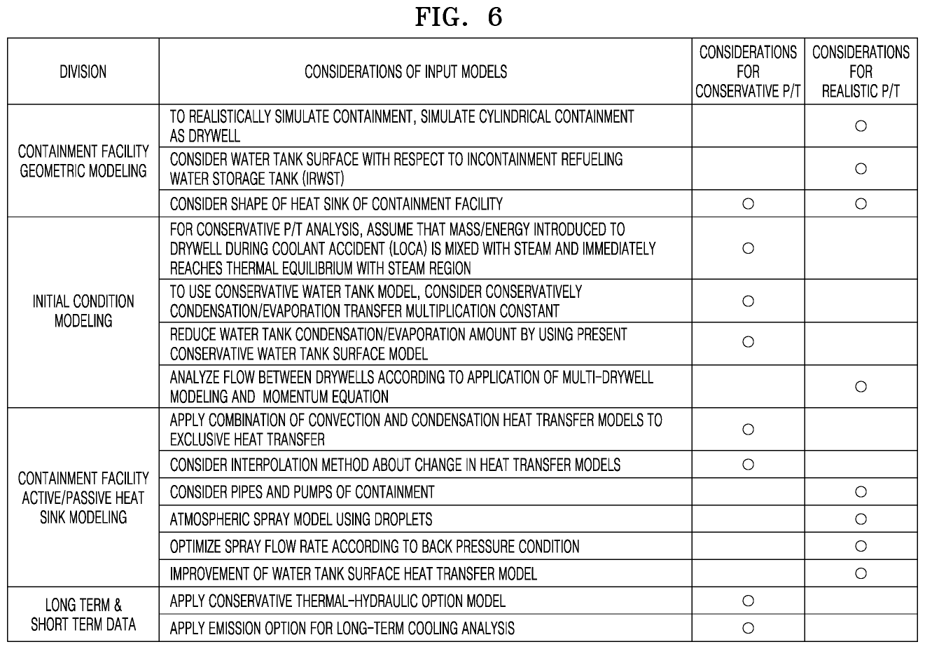

In operation S120 of performing short-term analysis modeling, as shown in FIG. 6, expected short-term M/E data may be calculated by using at least one of containment facility geometric modeling, initial condition modeling, and containment active/passive heat sink modeling or a method of combining the modeling above.

According to the containment facility geometric modeling, the containment is simulated with a drywell, and the geometry of the containment facility may be modeled by considering a water tank surface with respect to an in-containment refueling water storage tank (IRWST) and/or the shape of the heat sink of a containment facility having a new reactor type. In the containment facility geometric modeling, a condensation heat transfer film model in which condensation heat transfer through a containment facility heat sink is performed in the presence of non-condensable gas may be used. Accordingly, result values with higher accuracy and safety may be obtained.

In the initial condition modeling, to perform short-term analysis, it may be assumed that mass and energy flowing into a drywell is mixed into steam and immediately reaches thermal equilibrium with a steam region after mixing, and a condensation/evaporation transfer multiplication constant may be set to a preset value or less. In the initial condition modeling, a minimum value may be selected from among values of the condensation/evaporation amount in a water tank, which are calculated by using a water tank surface model. In the initial condition modeling, a flow rate between drywells may be calculated by applying multi-drywell modeling and a momentum equation. That is, in the initial condition modeling, in a state in which it is assumed that mass and energy flowing into a drywell is mixed into steam and immediately reaches thermal equilibrium with a steam region after mixing, and a condensation/evaporation transfer multiplication constant is set to a preset value or less, a minimum value may be determined from among values of the condensation/evaporation amount in a water tank, which are calculated by using a water tank surface model, and a flow rate between drywells may be calculated by applying multi-drywell modeling and a momentum equation.

In the containment facility active/passive heat sink modeling, an exclusive heat transfer situation may be set up by combining convection and condensation heat transfer models. In the containment facility active/passive heat sink modeling, a heat sink may be modeled by considering an interpolation method for a change of heat transfer models, and pipes and pumps of a containment. In the containment facility active/passive heat sink modeling, a heat sink may be modeled by using an atmospheric spray model using droplets. In the containment facility active/passive heat sink modeling, a flow rate of spray according to a back pressure condition may be optimized. In the containment facility active/passive heat sink modeling, an improved water tank surface heat transfer model may be used by setting a condensation heat transfer coefficient by a linear interpolation method. In the containment facility active/passive heat sink modeling, a water tank surface heat transfer model applying a Mechanistic method and a phasic bulk transfer method may be used.

In operation S130 of calculating long-term M/E data, emission of sensible heat and latent heat may be conservatively considered, and long-term M/E data may be calculated through linkages of back pressure conditions of a containment facility.

In operation S140 of performing long-term analysis modeling, expected long-term M/E value may be calculated based on the long-term M/E data. In operation S140 of performing long-term analysis modeling, a model that reasonably applies uncertainty according to a decay heat model may be used.

In operation S150 of analyzing the P/T of the containment facility using a CAP, an expected P/T value may be calculated by using one or more models. In operation S150 of analyzing the P/T, as shown in FIG. 5, an expected P/T value may be calculated by combining four types of models such as a flash model, an interface evaporation/condensation model, a condensation heat transfer model of a heat sink, containment facility geometric modeling, or the like. The flash model, the interface evaporation/condensation model, the condensation heat transfer model of the heat sink, and the containment facility geometric modeling are described in detail below.

Herein, the flash model may include a pressure flash model and a temperature flash model. The pressure flash model is a model that uses enthalpy and saturation characteristics defined based on a total pressure of a drywell in which emission M/E is performed. The temperature flash model may be modeled so that an introduced blowdown fluid is immediately mixed with steam and reaches a thermal equilibrium with a steam region. A flashing mass may be calculated by a following equation.

$${M}_{flash} = \frac{{M}_{i n} [ {h}_{i n} - {h}_{f} ]}{{h}_{s} - {h}_{f}}$$

Herein, each of variables is as follows.
[symbol] =Mass of blowdown fluid which flashes
[symbol] =Mass of blowdown fluid which enters the drywell
[symbol] =Specific enthalpy of blowdown fluid which enters the drywell
[symbol] =Specific enthalpy of fluid
[symbol] =Specific enthalpy of vapor

Herein, an evaporation/condensation model of an interface of a water tank surface and spray droplets may calculate an interaction between the water tank surface and the spray droplets according to three flow fields of continuous fluid, gas, and droplets.

An interaction between fluids on the water tank surface may include elements of forced convection and natural convection. Herein, the interaction of forced convection between fluids may be calculated by using a Linehan model. The interaction of natural convection between fluids may be calculated by using a Lloyd-Moran model. An interaction between gases on the water tank surface may include elements of forced convection and natural convection. The interaction of forced convection between gases may be calculated by using a Bank-off model. The interaction of natural convection between gases may be calculated by using a heat transfer model for a heating upward plate and a cooling upward plate. An action according to heat transfer between droplets and gases may be calculated by using a Mechanistic method and/or a Phasic Bulk transfer method. An action according to mass transfer between continuous fluid and droplets may be in accordance with de-entrainment and entrainment. De-entrainment and entrainment may occur between continuous fluids and droplets.

To calculate a conservative value with respect to the interaction between the water tank surface and droplets, a water tank surface condensation/evaporation transfer multiplication constant may be set to 1.0 or less.

Herein, at least one of a Uchida direct condensation model, a Tagami blowdown condensation model, a Tagami post blowdown condensation model, a film condensation model, and a pure steam condensation heat transfer model may be used as the condensation heat transfer model of the heat sink. Also, a diffusion layer model (DLM) may be used as a condensation heat transfer model in the presence of non-condensable gas. At least one of the Uchida direct condensation model, the Tagami blowdown condensation model, the Tagami post blowdown condensation model, the film condensation model, and the pure steam condensation heat transfer model may be used. Also, an interaction between condensation heat transfer of a heat sink may be calculated by using the DLM as the condensation heat transfer model in the presence of a non-condensation gas.

Herein, in the containment facility geometric modeling, containment may be simulated as a cylindrical containment. Also, in the containment facility geometric modeling, a water tank surface for the IRWST, a shape (cylindrical, vertical/horizontal plate) of a heat sink of a containment facility, a position (ground, ceiling) of the heat sink may be considered.

In operation S30 of evaluating the thermal-hydraulic analysis of the containment facility, expected P/T may be calculated through a model generated as a result of operation S20 of generating modeling, and the expected P/T is compared with a target value to perform evaluation for the modeling. In particular, operation S30 of evaluating the thermal-hydraulic analysis of the containment facility may include operation S160 of comparing.

In operation S30 of evaluating the thermal-hydraulic analysis of the containment facility, an expected P/T value of the containment facility may be calculated through M/E modeling and P/T modeling, and M/E modeling and P/T modeling may be evaluated by comparing whether the expected P/T value is within a target value.

In operation S160, the device 100 in FIG. 5 for the thermal-hydraulic analysis of the containment facility may determine whether the expected P/T value calculated in operation S150 is less than the target value. When the expected P/T value is less than the target value, the device 100 for the thermal-hydraulic analysis of the containment facility may determine the safety of the containment facility. The device 100 for the thermal-hydraulic analysis of the containment facility may confirm thermal-hydraulic analysis modeling to include a methodology that reaches a target value and a thermal-hydraulic model. The device 100 for the thermal-hydraulic analysis of the containment facility may confirm thermal-hydraulic analysis modeling by using CAP code.

When the expected P/T value is less than a pre-input target value, it may be determined that the containment facility is appropriately designed for a nuclear accident. When the expected P/T value is a pre-input target value or more, it may be determined that the containment facility is not appropriately designed for a nuclear accident. In this case, the device 100 for the thermal-hydraulic analysis of the containment facility may perform operation S170 of adjusting a P/T model of the containment. The device 100 for the thermal-hydraulic analysis of the containment facility may perform from operation S10 again by adjusting at least one of the short-term analysis modeling, the long-term analysis modeling, and the containment facility P/T model to be different from previously applied modeling (methodology). The device 100 for the thermal-hydraulic analysis of the containment facility may adjust a technical condition and calculate an expected P/T value again through the short-term analysis modeling, the long-term analysis modeling, and the containment facility P/T model. In particular, the device 100 for the thermal-hydraulic analysis of the containment facility may calculate an expected P/T value again by adjusting to increase a wall thickness of the containment facility. The device 100 for thermal-hydraulic analysis of the containment facility may calculate an expected P/T value again after adjusting to increase the cross section of a pipe.

Accordingly, a method and device for evaluating the overall safety of a nuclear power plant may be provided. In designing a nuclear power plant, numerical values for the overall safety of the nuclear power plant may be checked. The device 100 for the thermal-hydraulic analysis of the containment facility according to embodiments may generate and evaluate modeling that performs a thermal-hydraulic analysis of a containment facility through its own computer code. The device 100 for the thermal-hydraulic analysis of the containment facility according to embodiments may allow to obtain design conditions for a containment facility with high safety and reliability. The device 100 for the thermal-hydraulic analysis of the containment facility according to embodiments may increase the competitiveness of the nuclear industry by increasing the safety of design for nuclear reactors.

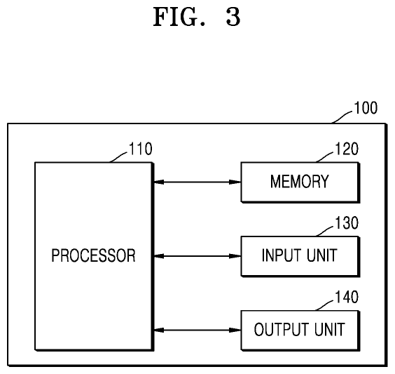

FIG. 3 is a block diagram of the device 100 for the thermal-hydraulic analysis of the containment facility, according to embodiments.

To evaluate a thermal-hydraulic analysis of a containment facility, the device 100 for the thermal-hydraulic analysis of the containment facility may set a technical standard, obtain data for short-term analysis and long-term analysis of the containment facility, perform modeling for short-term analysis and modeling for long-term modeling, and perform modeling for calculating an expected P/T value of the containment facility to evaluate a thermal-hydraulic analysis of the containment facility.

The device 100 for the thermal-hydraulic analysis of the containment facility may include a processor 110, a memory 120, an input unit 130, and/or an output unit 140.

The processor 110 may perform an operation of overall controlling the device 100 for the thermal-hydraulic analysis of a containment facility by using various programs stored in the memory 120. The processor 110 may include a processing device such as a microprocessor, a central processing unit (CPU), a processor core, a multiprocessor, an application-specific integrated circuit (ASIC), a field programmable gate array (FPGA), or the like, but the disclosure is not limited thereto.

The memory 120 may temporarily or permanently store data processed by the device 100. The memory 120 may include random access memory (RAM), read only memory (ROM), and a permanent mass storage device such as a disk drive, but the disclosure is not limited thereto.

The processor 110 may set a technical standard for a thermal-hydraulic analysis of a containment facility, generate modeling for short-term analysis, long-term analysis, and estimated P/T calculation, and evaluate the thermal-hydraulic analysis of the containment facility.

Setting the technical standard is the same as operation S10, and thus a description thereof is omitted. Performing modeling for short-term analysis, long-term analysis, and estimated P/T calculation is the same as operation S20, and thus a description thereof is omitted.

Evaluating a thermal-hydraulic analysis of a containment facility is the same as operation S30, and thus a description thereof is omitted.

The input unit 130 may input data for a thermal-hydraulic analysis of a containment facility. The input unit 130 may input a target value used in evaluation. The input unit 130 may include at least one of a microphone for receiving a voice input, a keypad for receiving a button input, and a touch pad for receiving a touch input.

The output unit 140 is a unit for outputting information, which may include at least one of a display unit for displaying an image, a speaker for outputting audio, and an interface for outputting information through a display device connected to an external device.

The device 100 for the thermal-hydraulic analysis of the containment facility may further include a communication unit communicating with an external device. The device 100 for the thermal-hydraulic analysis of the containment facility may obtain a target value through the communication unit. The device 100 for the thermal-hydraulic analysis of the containment facility may transfer data about generated modeling to the outside through the communication unit.

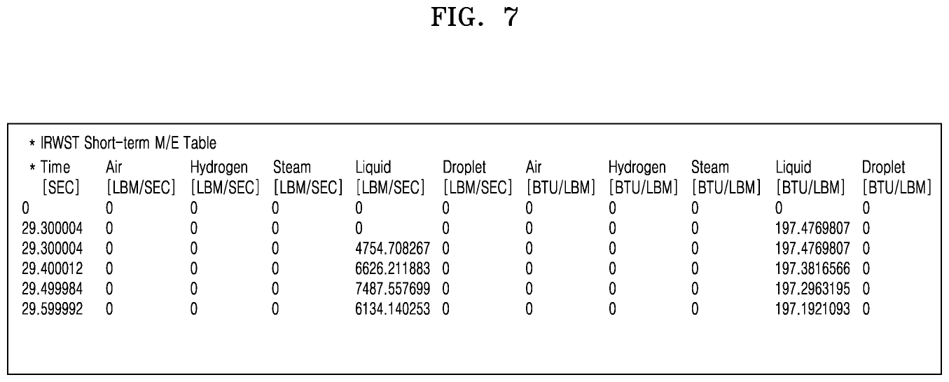

FIG. 7 is a diagram showing an example of short-term M/E data generated according to a first technical condition.

The table shown in FIG. 7 is a table in which a change (y axis) in mass and energy over time (x axis) is calculated. In atmosphere M/E data, mass may be expressed as mass rate and Energy rate.

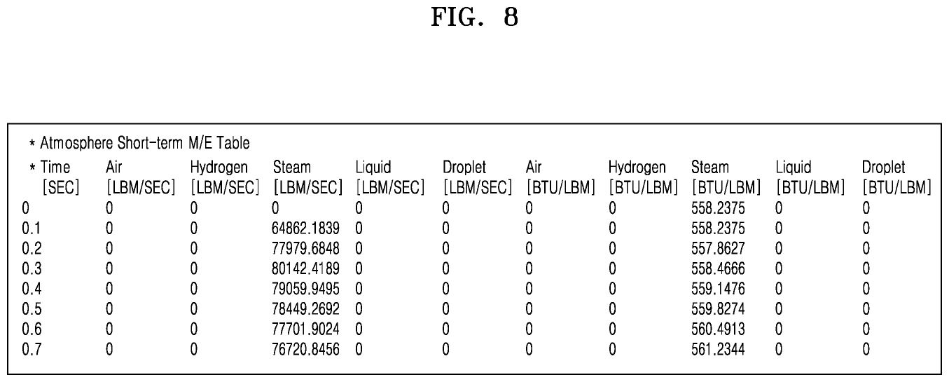

FIG. 8 is a diagram showing an example of short-term M/E data generated according to a second technical condition.

The table shown in FIG. 8 is a table in which a change (y axis) in mass and energy over time (x axis) is calculated. In IRWST M/E data, mass may be expressed as mass rate and Energy rate.

Energy may be expressed as an enthalpy value.

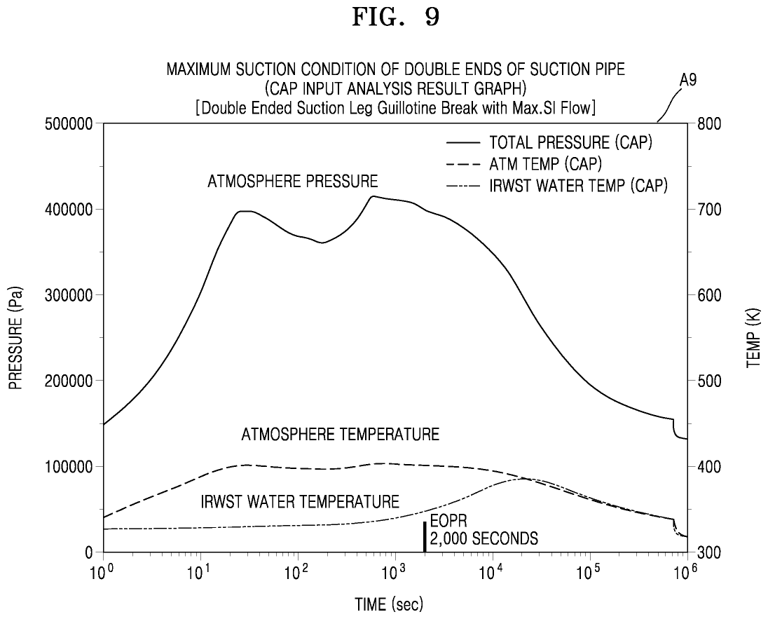

FIG. 9 is an example graph of expected P/T according to embodiments.

EOPR refers to a time point that is a basis of short-term data and long-term M/E data. M/E data before EOPR may be referred to as short-term M/E data. M/E data after EOPR may be referred to as long-term M/E data. As shown in FIG. 9, atmosphere pressure, atmosphere temperature, and/or a temperature of an IRWST may be included in M/E data. According to embodiments, atmosphere pressure, atmosphere temperature, and/or a temperature of an IRWST may be calculated as a graph that changes with time. As described above, M/E data before EOPR may be analyzed as short-term M/E data, and M/E data after EOPR may be analyzed as long-term M/E data.

The device described above may be implemented as a hardware component, a software component, and/or a combination of a hardware component and a software component. For example, the device and component described in the embodiments may, for example, be implemented by using one or more general-purpose or special-purpose computers, such as a processor, a controller, an arithmetic logic unit (ALU), a digital signal processor, a microcomputer, an FPGA, a programmable logic unit (PLU), a microprocessor, or any other device that may execute and respond to instructions. A processing device may execute an operating system (OS) and one or more software applications performed in the OS. Also, the processing device may also access, store, manipulate, process, and generate data in response to the execution of software. Hereinafter, for convenience of understanding, a case where one processing device is used is described, those skilled in the art may know that the processing device may include a plurality of processing elements and/or a plurality of types of processing elements. For, example, the processing device may include a plurality of processors or one processor and one controller. Also, other processing configurations, such as parallel processors, are also possible.

Software may include computer programs, code, instructions or a combination of one or more thereof, and may configure a processing device to operate as desired or may independently or collectively command processing devices. Software and/or data may be interpreted by a processing device, or may be permanently or temporarily embodied in a tangible machine, a component, a physical device, virtual equipment, a computer storage medium or device, or a signal to provide the processing device with instructions or data. Software may be distributed on computer systems connected through networks and stored or executed in a distributed manner. Software and data may be stored in one or more computer-readable media.

A method according to an embodiment may be implemented in the form of program instructions that may be executed through various computer units and recorded on a computer-readable medium. The computer-readable medium may include program instructions, data files, data structures, or the like, alone or in combination. The program instructions recorded on the computer-readable medium may be specially designed and configured for embodiments or may be known and usable to those skilled in computer software. Examples of the computer-readable medium include a magnetic medium such as a hard disk, a floppy disk, and a magnetic tape, an optical medium such as compact disc read-only memory (CD-ROM) and a digital versatile disc (DVD), a magnetic-optical medium such as a floptical disk, and a hardware device specially configured to store and execute program instructions, such as ROM, RAM, flash memory, or the like. Examples of program instructions include machine language codes such as those produced by a compiler and high-level language codes that may be executed by a computer using an interpreter or the like. The hardware device described above may be configured to operate as one or more software modules, and vice versa.

According to embodiments, a device and method of developing modeling through evaluation of a thermal-hydraulic analysis of a unique containment facility may be provided.

Also, according to embodiments, a device and method capable of obtaining orders for nuclear power plants of other countries and preoccupying a relative technological advantage among nuclear power plant developing countries may be provided.

In addition, according to embodiments, a device and method capable of designing a power plant through conservative and realistic modeling and reducing cost required for designing a power plant by optimizing a design margin of a containment facility may be provided.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the disclosure as defined by the following claims.

What is claimed is:

1. A method of evaluating thermal-hydraulic analysis of a containment facility, the method comprising:
inputting, by a device for thermal-hydraulic analysis of containment facility, data about a technical standard necessary for analyzing emission of mass and energy (M/E);
analyzing, by the device for the thermal-hydraulic analysis of containment facility, short-term M/E data, by using at least one of containment facility geometric modeling, initial condition modeling, and containment facility active/passive heat sink modeling;
analyzing, by the device for the thermal-hydraulic analysis of the containment facility, long-term M/E data by reflecting linkages of back pressure conditions of the containment facility;
calculating, by the device for the thermal-hydraulic analysis of the containment facility, an expected pressure and temperature (P/T) value by applying the short-term M/E data and the long-term M/E data to at least one of a flash model, an interface evaporation/condensation model, a condensation heat transfer model of a heat sink, and containment facility geometric modeling; and
evaluating, by the device for the thermal-hydraulic analysis of the containment facility, that the containment is stable safe when the expected P/T value is less than a preset target value, and evaluating that the containment is not stable safe when the expected P/T value exceeds the preset target value.

2. The method of claim 1, wherein the data about the technical standard comprises data reflecting at least one of a general design criteria (GDC), a standard review plan (SRP), and American National Standards Institute (ANSI).

3. The method of claim 1, wherein, in the containment facility geometric modeling, the containment facility is simulated with a cylindrical drywell, the containment facility is simulated by reflecting an in-containment refueling water storage tank (IRWST) and a heat sink phenomenon of a new reactor type, and modeling is performed with respect to heat transfer through a heat sink of the containment facility by using a condensation heat transfer film model in which non-condensable gas exists is used.

4. The method of claim 1, wherein, in the initial condition modeling, the containment facility is simulated with multi-drywells, and modeling is performed with respect to condensation heat transfer by using a diffusion layer model (DLM), or Uchida/Tagami model.

5. The method of claim 4, wherein, in the initial condition modeling, when a containment coolant flows into a containment drywell, modeling is performed by assuming that the coolant is immediately mixed with steam to reach thermal equilibrium.

6. The method of claim 5, wherein, in the initial condition modeling, modeling is performed by using a water tank surface model in which a condensation mass transfer multiplication constant is set to a number of 1.0 or less.

7. The method of claim 6, wherein, in the initial condition modeling, modeling is performed by using a Linehan model and a Lloyd-Moran model.

8. The method of claim 1, wherein, in the containment active/passive heat sink modeling, modeling is performed by using a linearly interpolated condensation heat transfer model.

9. The method of claim 1, wherein, in the containment active/passive heat sink modeling, modeling is performed by using a linearly interpolated Uchida model.

10. The method of claim 1, wherein, in the containment active/passive heat sink modeling, modeling is performed by using a water tank surface heat transfer model to which a Mechanistic method and a Phasic Bulk transfer method are applied.

11. The method of claim 1, wherein the calculating of the expected P/T value is performed by using modeling implemented by using a containment analysis package (CAP) code.

12. A computer-readable storage medium having instructions for executing the method of claim 1 stored thereon.
